(19) United States
(12) Patent Application Publication
(10) Pub. No.: US 2026/0094042 A1
(43) Pub. Date: Apr. 2, 2026

(54) METHOD FOR PERFORMING QUANTUM ANNEALING

(71) Applicant: Budapesti Muszaki és Gazdaságtudományi Egyetem, Budapest (HU)

(72) Inventors: Márton Kormos, Pécel (HU); András Grabarits, Budapest (HU); Dominik Szombathy, Érd (HU); Gergely Attila Zaránd, Budapest (HU)

(21) Appl. No.: 18/901,908

(22) Filed: Sep. 30, 2024

(51) Int. Cl. G06N 10/60

(52) U.S. Cl. CPC G06N 10/60

(57) ABSTRACT

The invention is a method for performing quantum annealing utilizing a quantum computer comprising quantum bits or a classical computer simulating the quantum bits, comprising
a system Hamiltonian describing the quantum bits is determined (S105, S110), comprising initial and problem Hamiltonian,
an annealing protocol is determined (S120), wherein initial Hamiltonian and problem Hamiltonian are multiplied by
   a first annealing coefficient being unit at the beginning and zero at the end, and
   a second annealing coefficient being zero at the beginning and unit at the end
of annealing, respectively,
annealing is performed (S130), as a result of which a final energy is obtained (S135),
   wherein a complex conjugation symmetry breaker Hamiltonian is involved (S115) in the system Hamiltonian, which is multiplied by a third annealing coefficient being zero at the beginning and at the end of annealing. (FIG. 1)

### TECHNICAL FIELD

The invention relates to a method for performing quantum annealing.

### BACKGROUND ART

Various industrial and scientific problems (e.g. traffic optimization, economics, and engineering optimization problems) can be formulated as a minimization of a cost function that measures how far a given configuration is from the desired solution. The cost function can be viewed as an energy function of some physical system; thus, the problem is translated to finding the lowest energy state (ground state) of the system. For classical system, the cost function can be identified as the Hamiltonian function, while for quantum systems, it gives the energy eigenvalues of the Hamilton operator (in quantum mechanics, the Hamiltonian describes the energy and the time evolution of a quantum-mechanical system; in finite dimensional systems, it can be represented by finite matrices; the ground state of the Hamiltonian corresponds to the eigenvector with the smallest eigenvalue of this matrix).

Classical optimization problems are usually formulated in terms of classical variables. These are often represented by bits (Boolean variables) taking values of 1 and 0, but other classical variables are also used. The goal is to find configurations (bit sequences) that minimize (or maximize) a given cost function. The cost function imposes constraints upon the bits, and the solution corresponds to satisfying all or the maximum number of these constraints simultaneously.

One of the most famous binary optimization problems is the 3-SAT problem (3-satisfiability problem, see Aho, Alfred V.; Hopcroft, John E.; Ullman, Jeffrey D. (1974). The Design and Analysis of Computer Algorithms. Addison-Wesley. p. 403.), where N bits are randomly put into M 3-bit clauses i.e., Boolean functions of the 3 bits that assign values 0 or 1 to the 3 bits. The solution of the problem is given by bit configurations which satisfy (give the value 1 for) all clauses, or, if it is not possible to satisfy all clauses, then the maximal number of them (max-3-SAT problem).

This and other optimization problems naturally appear in traffic optimization, economics, and engineering optimization problems. One usually applies non-deterministic stochastic (Monte Carlo) methods (such as the simulated annealing, or genetic algorithms), since compared to these the deterministic algorithms are ineffective (the time needed for finding the solution may be very long, the necessary time grows fast with the size of the problem).

Herebelow, some definitions and information are given about devices and architectures utilized in the field of the invention.

Quantum devices are physical systems designed to manipulate and utilize quantum properties, such as superposition and entanglement, for example, to find solutions to mathematical problems, like optimizations, finding eigenvalues, or the solutions of linear systems of equations. In quantum devices, transport of information can happen in various non-classical ways. Examples are superconducting circuits or circuits where information is some current of spin waves, used in spintronics or platforms utilizing ultracold gases of neutral atoms trapped and manipulated by laser fields.

Qubits, short for “quantum bits” (both names are widely used throughout this description), are the fundamental units of quantum information in quantum computing. Unlike classical bits, which can only be in a state of 0 or 1, qubits can exist in a superposition of the two states simultaneously. This unique property enables quantum computers to perform certain calculations exponentially fast compared to classical computers for specific problems. In a classical computer, bits are represented by physical systems, like transistors, which can be in one of two states: on (1) or off (0). In contrast, qubits are typically realized using quantum systems, such as the spin of an electron, the polarization of a photon, or the energy levels of an atom.

These quantum systems can exist in a coherent superposition of 0 and 1, until measurement yields one of the two states. Furthermore, qubits can be entangled, a phenomenon where the state of one qubit becomes dependent on the state of another, even if they are physically separated. This entanglement is a key factor that gives quantum computers immense potential for solving certain problems much more efficiently than classical computers. For the description of quantum bits see for example US 2021/0241143 A1 and also some further details below.

A quantum computer is a device that operates under the laws of quantum mechanics and physical phenomena that are only observable in quantum systems and not in classical setups. In some cases, it enables us to process information in an efficient way utilizing superposition and entanglement.

Herebelow, some details about the technical context of the relevant field are given.

Quantum annealing is a general framework to find low energy states, or with high probability the ground state of Hamiltonians encoding classical combinatorial problems (wherein, accordingly, an adiabatic process is performed). It is similar to classical simulated annealing where classical Monte Carlo moves make it possible to move between configurations, and possibly converge to lower lying energy configurations. In the course of the quantum annealing algorithm quantum fluctuations help the system explore the space of many-body configurations. This makes it possible to find the desired ground state with finite probability, in other words to find with a large probability the state minimizing the energy, i.e., the cost function.

In quantum annealing, one starts from the ground state of a known and simple Hamiltonian, H₀, which one gradually transforms to a problem Hamiltonian, Hₚ (see also below), both realizable on a quantum computer. If this deformation is slow enough, then with a high probability one remains close to the ground state, and the computation delivers low-energy states of Hₚ, that is optimized configurations of the cost function, represented by Hₚ. It is hoped that, beside the already existing ones, some quantum annealing schemes will outperform their classical counterparts.

Quantum optimization is a computing method based on quantum mechanical processes aiming to find the optimal solution to complex problems more efficiently than classical methods by using quantum algorithms and leveraging qubit properties like superposition and entanglement. Quantum optimization can explore multiple possibilities simultaneously, potentially leading to faster and more accurate results. It holds promise for solving challenging optimization problems in fields such as logistics, finance, and machine learning.

Herebelow, relevant prior art in the field and some aspects thereof are introduced.

A method for quantum annealing is patented in U.S. Pat. No. 11,403,548 B2. A further document about optimizing annealing parameters is US 2021/0241143 A1.

An intermediate Hamiltonian operator occurs in connection with adiabatic calculations in US 2021/0166148 A1.

Furthermore, in the article T. Albash: Role of nonstoquastic catalysts in quantum adiabatic computation, Physical Review A 99, 042334 (2019) (in the following: Albash article) an interpolation Hamiltonian is introduced having an intermediate term beside the initial (easy-to-solve/prepare) Hamiltonian and the problem Hamiltonian (see Eq. (4) of the document). The intermediate term uses a σₓ*σₓ (or Sₓ*Sₓ, where Sₓ=h_{bar}/2*σₓ, where h_{bar}=h/(2π), h is the Planck constant) type expression (see Eqs. (1) and (4) of the Albash article).

In the article of Z. Tang and E. Kapit: Unconventional quantum annealing methods for difficult trial problems, Physical Review A 103, 032612 (2021) (in the following: Tang and Kapit article) a similar intermediate Hamiltonian is introduced as in the previous article (see Eq. (11) of the document).

In both the Albash article and the Tang and Kapit article, the intermediate Hamiltonian term is introduced with a prefix of ‘s(1−s)’ where ‘s’ is the adiabatic parameter (in other words, annealing or interpolation parameter) having a value of 0 at the beginning and a value of 1 at the end of the process. Thus, at the beginning and at the end, the intermediate Hamiltonian vanishes.

Furthermore, in Eq. (13) of the Tang and Kapit article a Hamiltonian term is a combination of a first term with cosine prefix and a second term with sine prefix. This equation of the Tang and Kapit article is also mentioned in another article of Kapit cited in the Tang and Kapit article (E. Kapit and V. Oganesyan: Noise-tolerant quantum speedups in quantum annealing without fine tuning, Quantum Science and Technology, vol. 6, 025013 (2021), in the following: Kapit and Oganesyan article), where it is stated that “it preserves the instantaneous energy spectrum in evolution, since it is equivalent to the standard transverse field Hamiltonian through a simple basis rotation”.

A further article in connection with quantum annealing—illustrating a further type of approach using σₓ*σₓ type term—is Y. Seki and H. Nishimori: Quantum annealing with antiferromagnetic fluctuations, Physical Review E 85, 051112 (2012).

It is noted furthermore that qubits called ancillary qubits are sometimes used in quantum circuits that operate using quantum gates (see herebelow). The ancillary qubits can have many possible roles such as mediating interactions, facilitating readout, performing error correction tasks, and many other uses, but this is not related to quantum adiabatic computations.

The application of ancillary qubits in connection with quantum error connection is disclosed e.g. in US 2022/0029639 A1, U.S. Pat. No. 11,194,659 B2, U.S. Pat. No. 11,455,207 B2 and U.S. Pat. No. 11,599,817 B2.

A gate-based quantum computing approach using ancillary qubits is disclosed in US 2022/0207402 A1. This approach uses operators responsible for time evolution which are naturally unitary type operators. Furthermore, this approach uses ancillary particles for mediating interaction between a subgroup of qubits.

In US 2023/0106489 A1 a qubit system applicable in quantum computations is disclosed. It is mentioned in the document that this system may be exemplary applied in adiabatic quantum computations, but the way of this is not given.

In US 2023/0214700 A2 symmetry-breaking with special meaning is applied in quantum variational algorithms. In this document everything is called symmetry-breaking which does not commute with a specific term in the Hamilton operator. In US 2023/0214700 A2 various type of operators are added to the Hamiltonian, and the parameters of these are optimized by the help of a classic computer. In this document, they want to speed up the process with the help of control fields compared to adiabatic evolution.

In view of the known approaches, there is a need for a method for quantum annealing which show higher efficiency than the prior art approaches.

### DESCRIPTION OF THE INVENTION

The primary object of the invention is to provide a method for quantum annealing, which is free of the disadvantages of prior art approaches to the greatest possible extent.

A further relevant object of the invention is to speed up quantum annealing process. This speedup is achieved in the method according to the invention by including an additional symmetry breaker Hamiltonian that possesses less symmetry than the problem Hamiltonian (see also below for the details of these symmetry aspects), namely is breaks complex conjugation symmetry.

Herebelow, the technical problem to be solved is introduced.

One model of quantum computing is adiabatic quantum computing or its application for optimization problems, quantum adiabatic optimization. Adiabatic quantum computing is mainly used to find the solution of optimization problems, however, in general, it is not possible to exclude quantum annealing processes that give wrong results. In essence, the goal is to optimize quantum computation such that it achieves the solution to a given problem with the same or higher probability in less time compared to prior art approaches.

The method according to the invention defined below is a special case of quantum annealing. Here the goal is to find the ground state of a Hamiltonian representing the cost function associated with the combinatorial problem. The cost function gives zero penalty/cost, when the solution is found, which is associated with the ground state of the problem Hamiltonian.

The ground state or a state close to it in quantum adiabatic optimization is reached from another Hamiltonian's ground state (see the next equation, the process starts from H₀). One of the most important requirements in this framework is that the initial ground state can be found easily (i.e. the ground state of H₀) and if the time-evolution is slow enough (i.e. the system evolves adiabatically) the final time-evolved state will be close to the final ground state.

However, many times, the energy levels during the deformations approach each other sufficiently close such that adiabatic evolution can only be maintained by very slow time-evolutions which can lead to even longer processes than what is required by classical algorithms.

In general, in the scheme introduced above

$$H ( λ ) = λ {H}_{p} + ( 1 - λ ) {H}_{0} ,$$

where λ is a time-dependent parameter, typically goes from 0 to 1, i.e. in H(λ) is transformed from H₀ to Hₚ (as touched upon above).

To ensure adiabatic evolution with good precision, the following condition must be satisfied. Namely, the transition rate between the ground state and first excited state, as dictated by the Schrödinger equation, must remain small compared to the energy difference of the states. The transition rate can be expressed as the matrix element of the time derivative of the Hamiltonian between the two states divided by the square of the corresponding energy difference (this is included by the help of a combination of a derivative of the Hamiltonian according to A and the time derivative of λ with which the expression is multiplied), so the condition in mathematical terms is given by

$$\dot{λ} \frac{\vert 〈 1 \vert \frac{d H ( λ )}{d λ} \vert 0 〉 \vert}{δ {E}_{1 , 0}^{2}} ≪ 1$$

meaning that the transition amplitudes between the instantaneous ground state and the first excited state is small enough that no excitations happen, where |0> and |1> are the ground state and the first excited state of H(λ), and δE_{1.0} is the energy difference therebetween (moreover, the fraction is multiplied by the first time derivative of λ; this is a constant value in the case of linear time dependence). To ensure this, various parameters are to be tuned, or different protocols are commonly applied to either speed up the evolution or increase the typical energy gaps.

The bottlenecks of adiabatic optimization are therefore those points along the path in the space of the parameters of the Hamiltonian, where the ground state and the first excited state get very close to each other and form a so-called avoided level crossing (or anticrossing). Even when the speed of the process is slow enough with respect to the average transition rate, at these avoided crossings the speed needs to be reduced by orders of magnitudes in order to satisfy the adiabatic condition.

Another important issue in quantum adiabatic optimization is coherence time. Any quantum apparatus is susceptible to noise, and preserving quantum information from noise becomes increasingly difficult as the computation time increases. Extending the total computation time beyond the coherence time of a quantum device can pose a challenge. Identifying a means to reduce the computation time without compromising the accuracy of computational outcomes becomes therefore crucial. Accordingly, the whole calculation cannot last for a long time to maintain the quantum character and the coherence of the system. The coherence time depends on the implementation, so it is important for the invention to be able to perform the calculations as fast as possible. This is preferably an important object of the invention.

It is a main object of the invention to solve the above-detailed technical problem. According to our tests and numerical evidences—referring to the description and figures below—the invention is able to solve this technical problem. The invention can advantageously reduce the computation time very effectively.

The objects of the invention can be achieved by providing the method according to claim 1. Preferred embodiments of the invention are defined in the dependent claims.

### BRIEF DESCRIPTION OF THE DRAWINGS

Preferred embodiments of the invention are described below by way of example with reference to the following drawings, where

FIG. 1 is a flowchart of an embodiment of the method according to the invention,

FIG. 2 illustrates atomic levels of Rb-87,

FIG. 3 illustrates an exemplary realization of a qubit system,

FIG. 4 illustrates another exemplary realization of a qubit system

FIGS. 5-7 illustrate the results on a first exemplary system,

FIGS. 8-10 illustrate the results on a second exemplary system.

### MODES FOR CARRYING OUT THE INVENTION

### 1. Annealing Framework and its Application in Embodiments

The disclosure of the invention and its embodiments is hereby started by an introduction for describing further details of the annealing (adiabatic) framework and its application in the embodiments of the invention.

It is noted hereby that, advantageously, by the help of the quantum annealing method according to the invention a significant reduction of a non-classical (e.g., quantum) computational time can be achieved.

Furthermore, the invention is applicable to solve classical optimization problems. In the invention it is considered to be given how to encode classical optimization problems into configurations of binary variables taking values of zero and one.

The problem is then encoded in a cost function that measures how much a received given bit configuration differs from the solutions. Multiple encodings may apply with the requirement that the cost function takes zero for the bit configurations that solves the optimization problem.

A problem Hamiltonian (see Hₚ above and also below) matrix is constructed of the same dimension as the space of the different bit configurations. The solution of the problem is encoded in the ground state of the Hamiltonian (i.e. the ground state configuration of spins is the solution of the problem).

The Hamiltonians may be constructed either on a digital platform of a classical computer (which can be also called (normal) digital computer—referred to like this elsewhere—or non-quantum computer; the name classical computer is used in order to distinguish it from the quantum computer), as computer simulations, or in experimental setups, by analogue quantum computers as well as any programmable quantum computer.

Preferably, the system Hamiltonian for a plurality of quantum bits can be represented (can be described) by Pauli operators, as also the illustrations below show. However, other representations are conceivable for a quantum bit in a Hamiltonian, naturally, also for symmetry breaker operator term for breaking complex conjugation symmetry (see in the description part, where the relation between the embodiments and special embodiments is discussed, along with possible generalizations).

Also, referring to the above definition of quantum bits (qubits), the quantum bit is therefore a two-state system the mathematical description of which can be based on Pauli operators, i.e. it can be described by a formalism that can be applied also to a spin ½. In connection with this, we refer to the details below, where exemplary implementation of a quantum bit is also disclosed (see especially Eqs. (8) and (9)).

An initial Hamiltonian (see also H₀ in the expression above and also below) is chosen from where the quantum annealing, the quantum adiabatic optimization process is initiated. Its requirement is that its ground state or other energy states connected by adiabatic deformations to the target state of the problem Hamiltonian, shall be obtained easily either in experimental setups or in computer simulations. In addition, initial Hamiltonians, based on the problem, may also be tailored so that they facilitate adiabatic evolution towards the final Hamiltonian.

For instance, in the spin Hamiltonian representation, a typical choice for the problem Hamiltonian is

$${H}_{P} = {\sum }_{i , j = 1}^{N} {J}_{i , j} {Z}_{i} {Z}_{j} + {\sum }_{i = 1}^{N} {h}_{i} {Z}_{i} , \qquad ( 1 )$$

while the initial, easy-to-prepare Hamiltonian may be

$${H}_{0} = - {\sum }_{i = 1}^{N} {X}_{i} \qquad ( 2 )$$

In the equations, Xᵢ, Yᵢ, Zᵢ denote the Pauli operators (could also be denoted by Oxi, σ_{yi}, σ_{zi}) for the i^{th} qubit.

The followings are noted. As mentioned above, quantum bits (shortly, qubits) can exist in a superposition of two states simultaneously. The states can be labelled by 0 and 1, regardless of that the eigenvalues of Z (Pauli operator of type z) are −1 and 1 (eigenvalues of S_{z} are −h_{bar}/2 and h_{bar}/2, where h_{bar}=h/(2×)—which is often chosen to be 1, with which eigenvalues of ±½ are obtained—where h is the Planck constant). Usually, also these eigenvalues can be used for labelling these states. This is typically done in the field of quantum information.

The annealing schedule and the time-evolution protocol may be chosen in multiple ways based on the initial problem, the combinatorial problem, the cost function representation of the problem, the Hamiltonian representation of the problem, and the cost function, the target state of the problem Hamiltonian, the prepared state of the initial Hamiltonian and the breaker Hamiltonian, and the applied platform, either computer-based or in experimental setups.

The efficiency of a quantum adiabatic optimization algorithm strongly depends on the process time and the chosen precision, i.e., the probability of finding the final target state of the problem Hamiltonian.

The method according to the invention efficiently speeds up annealing processes by including in the schedule an additional symmetry breaker Hamiltonian term. The symmetry breaker term (or symmetry breaking term) lowers the fundamental symmetries of the system (i.e. breaks the complex conjugation symmetry), which, as a very advantageous consequence, increases the typical gap sizes at the problematic avoided level crossings. There may be a time-evolution protocol of the weights of the initial and problem Hamiltonians to control the position of the avoided level crossings and, thus, speed up the convergence.

The symmetry breaker Hamiltonian term must possess less symmetry than the other Hamiltonian terms (H₀, Hₚ) during the process (namely, the former Hamiltonian breaks, the latter Hamiltonians possess complex conjugation symmetry). A further requirement is that the problem Hamiltonian can be reached from the initial Hamiltonian by adiabatic deformations by the time-evolution protocol with the symmetry breaker Hamiltonian term as well.

Speed-up is demonstrated on the one hand for the unitary symmetry breaker case (see Eq. (6) below; not to be confused with the unitary operators responsible for time evolution) when the problem Hamiltonian possesses complex conjugation symmetry and the symmetry breaker terms break complex conjugation symmetry throughout the process, lowering it to the unitary symmetry group.

A better speed-up efficiency is also demonstrated in the symplectic symmetry breaker case (see Eq. (7) below), where the symmetry breaker term breaks the symmetry of complex conjugation, while preserving an additional symmetry (a kind of reflection symmetry, see below), while the Hilbert-space is doubled according to the inclusion of an ancilla qubit (see 2 below). In this case, HΩ=ΩH*, with 2 a real, non-singular, skew-symmetrical matrix, usually chosen as Ω={{0,Id}, {−Id,0}. Ω contains blocks, ‘Id’ corresponds to the identity operator on the original Hilbert space (Hilbert-space doubles with every ancilla qubit, in case of multiple ancilla qubits).

A possible implementation of symplectic symmetry breaking is to couple one or more (several) auxiliary ancilla qubit(s) to the problem qubit (elsewhere called base quantum bit) system (an ancilla qubit is an extra spin−½ degree of freedom). This symmetry breaker term breaks invariance to complex conjugation of the qubit system, while preserves an overall reflection symmetry which amounts to complex conjugation of the problem qubits and a simultaneous time reflection of the ancilla qubit. The coupling between the problem and ancilla qubits ensures that the product of the two transformations leaves the total Hamiltonian invariant, so any measurable quantity will remain unchanged under such transformation.

The breaker Hamiltonian may have many parameters depending on the annealing schedule, the time-evolution protocol of the initial and problem Hamiltonian, the target energy state of the problem Hamiltonian, and the optimization probability as well: in the unitary embodiment, for instance, the degree of the complex conjugation symmetry breaking may be different for each qubit and may follow different time-evolution protocols. In the symplectic embodiment (see below) the strength and the form of the coupling between the auxiliary and problem qubits may also be different for each problem qubit and may also follow different time-evolution protocols as long as the symmetry lowering requirement is fulfilled.

The symmetry of the symmetry breaker term depends on the overall symmetry of the deformed Hamiltonian. Since, in the invention the symmetry breaker term breaks the complex conjugation symmetry, the initial and problem Hamiltonian (chosen or utilized in the method according to the invention) do have complex conjugation symmetry in themselves. This is meant by the name of the complex conjugation symmetry breaker operator term, i.e. that it effectively breaks complex conjugation symmetry, it is the only term in the system Hamiltonian which breaks complex conjugation symmetry. Accordingly, the symmetry breaker term and the initial and problem Hamiltonian are chosen in a way that the former breaks down the complex conjugation symmetry possessed by the initial and problem Hamiltonian (i.e. the initial Hamiltonian and the problem Hamiltonian have complex conjugation symmetry; this is naturally given in the case when the problem Hamiltonian is originated from a—typically real (not complex)—cost function).

The time evolution protocol of the weights of the initial and problem Hamiltonians controls the position of the avoided level crossings, therefore the time-evolution of the symmetry breaker Hamiltonian may follow different protocols determined by the annealing schedule between the initial and problem Hamiltonians. It may be switched on and off continuously or discontinuously (at specific times), its weight may reach values of the same order as the maximum weight of the initial or the problem Hamiltonian, but it may also exceed it considerably (its dependence on the annealing parameter is controlled by the help of a third annealing coefficient function, see below).

To enhance further the efficiency of the quantum adiabatic optimization both above detailed (and more general) embodiments (unitary and symplectic) can be applied successively (i.e. a combination of these can be applied). For example, more and more qubits can be coupled to the deformed Hamiltonian and the already coupled qubits, or additional terms can be added to the schedule that also breaks down the complex conjugation symmetry of the coupled qubits. The different methods, multiple qubit couplings and their possible symmetry lowering methods can be applied simultaneously by switching off one of the breakers and switching on another type during the process. In this case, their protocols may follow the ones in the annealing schedule with only one breaker, but they may be chosen such that their simultaneous effect results in even shorter annealing times.

### 2. Advantages of the Invention, Exemplary Parametrization, Embodiments

Herebelow, some technical implementations and advantages of the invention are given. The invention preferably uses a programmable quantum computer or quantum simulator (in general, a quantum computer based on a plurality of quantum bits or a classical computer simulating the plurality of quantum bits, respectively, see below) for performing adiabatic calculation (i.e. for the implementation thereof, see also below).

In the calculation, a control parameter (in general, annealing parameter) λ∈[0, 1] is preferably used for tuning, where varying of λ can be performed very slowly, i.e. adiabatically (cf. with the expression H(λ)=λHₚ+(1−λ) H₀ in the introduction and see below the following points for details).
At λ=1 the quantum computer or quantum simulator realizes a classical problem Hamiltonian, Hₚ acting on qubits i=1, . . . , N.
The optimization task is to find a state q minimizing Hₚ.
At λ=0 the simulator realizes a simple classical or quantum problem, H₀.
The invention uses a symmetry-breaker, Hₛ. The symmetry-breaker influences the statistics of the eigenenergies of αH₀+βH_{P}, and advantageously suppresses nonadiabatic processes as well as speeds up computational times.
Hₛ is a programmable system Hamiltonian term, acting in an embodiment on base qubits and ancilla qubits a=1, . . . , A (see below examples for symmetry breaker Hamiltonians)
The quantum computer or quantum simulator can realize any linear combination:

$$H = α ( λ ) {H}_{0} + β ( λ ) {H}_{P} + γ ( λ ) Hs . \qquad ( 3 )$$

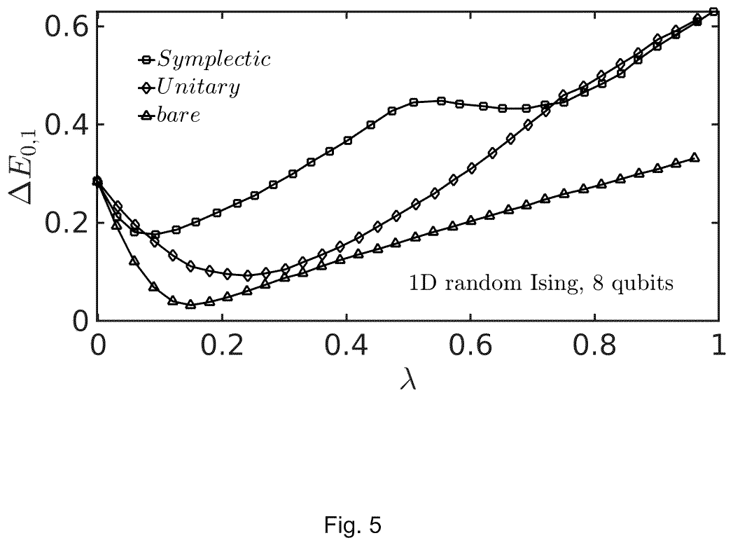

The linear coefficients have the property: α(1)=β(0)=γ(0)=γ(1)=0, and α(0)=β(1)=1. Possible but not exclusive, i.e. exemplary choices are α=1−λ, β=λ, γ=4λ(1−λ) (see also below for details). This exemplary scheme is utilized for our simulations illustrated in FIGS. 5-10 (in these figures, in the ‘bare’ case there is no symmetry-breaker Hamiltonian, Hₛ=0, i.e. this is a conventional annealing approach; for the cases ‘unitary’ and ‘symplectic’ see the utilized symmetry-breaker Hamiltonian herebelow, in the next sections). The constant in the expression of γ may be in general a variable c (above, c=4), i.e. the above expression may be written in general γ=cλ(1−λ). α and β also may have a respective multiplicative constant such as variable c. Preferably, the weight of the symmetry breaker term reaches values of the same order as the maximum weight of the initial or the problem Hamiltonian, but it can also exceed significantly their weight. The protocol is determined based on the annealing schedule between the initial and problem Hamiltonians.
The control parameter preferably changes linearly in time: λ(t)=t/T. The computation time for the annealing—in case of more cycles, for one cycle—is T. However, the control parameter can have any other time dependence such that λ(0)=0, λ(T)=1 (see also below for other information and choices). It is noted that this typical choice (and other choices) for the time dependence of the annealing parameter may be implemented in a continuous or quasi-continuous (in small discrete steps) manner on a quantum computer or on a classical computer (see also below).

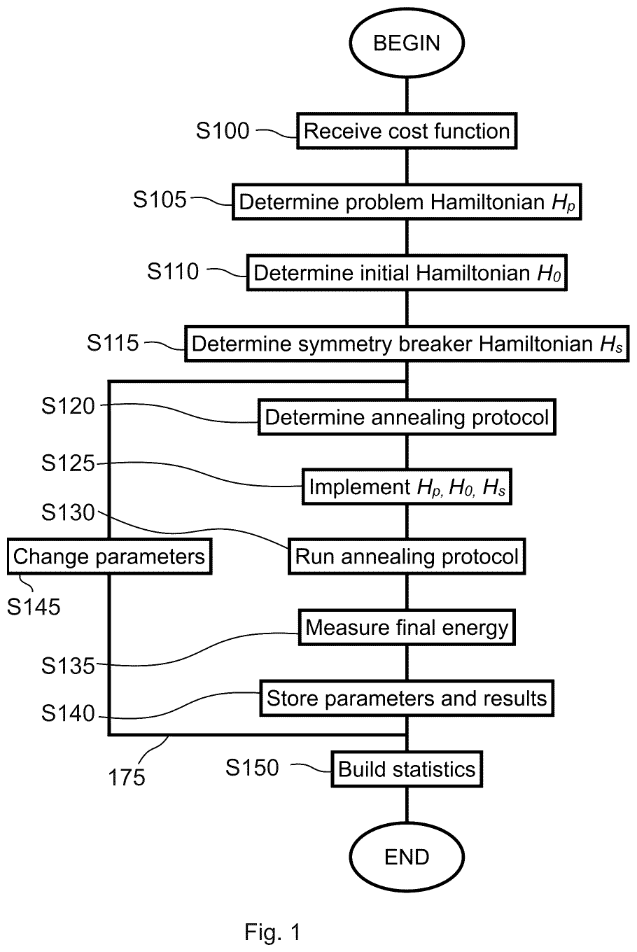

Accordingly, herebelow, the whole computation process corresponding to the annealing is discussed by the help of the flowchart of FIG. 1 illustrating an embodiment. The computational protocol in an embodiment is summarized in the flowchart of FIG. 1.

First, the cost function is received in an operational step S100 which defines the optimization problem to be solved (in other words, the cost function is available). The cost function may be constructed based on e.g. a combinatorial problem.

In an operational step S105, the cost function is translated into a problem Hamiltonian, Hₚ (this step can be performed on a classical computer). Accordingly, the associated problem Hamiltonian, which encodes the solution of the problem in its ground state is obtained.

The initial Hamiltonian (H₀) is determined (chosen) in an operational step S110 based on the requirement that both the Hamiltonian and its ground state are easy to prepare. The problem Hamiltonian is considered to be given (since it is the problem, it preferably comes from the cost function) for which it is easy to choose an initial Hamiltonian (it is a straightforward choice as above Eq. (2) illustrates).

Then the symmetry breaker term is chosen in an operational step S115 (in the special/detailed embodiments below, it is either the unitary or the symplectic symmetry breaker term, see also for possible generalization of these). Its specific form is also fixed at this step.

After the preparatory steps, the choice of the annealing protocol (see operational step S120) is the next step, i.e. the time dependence of the various terms in the total Hamiltonian (in the present embodiment, operational step S120 is the first step being part of a loop corresponding to operational step S135). An annealing schedule is preferably determined that fits the three Hamiltonians from the respect of speeding up the adiabatic evolution. An example is given hereabove for the annealing schedule. It is noted, however, that the optimization of the annealing protocol is not an emphasized part of the invention. Rather, the main contribution of the invention is the utilization of a symmetry breaker term.

In the present embodiment of the method, the next step is the implementation of the different terms in the Hamiltonian (see operational step S125, see below for exemplary implementation). The three Hamiltonians are preferably implemented in experimental setup (i.e. on a quantum computer based on quantum bits) or computer-based setup (i.e. in a classical computer simulating the quantum bits).

The adiabatic computation—i.e. running the annealing protocol in operational step S130—is performed by varying the couplings in time (i.e. the respective coefficients of the Hamiltonian terms as a function of λ, for exemplary dependencies on parameter λ, see above) according to the annealing protocol (this is done by adjusting the frequencies, the power, and the phase of the lasers and/or by rearranging the atoms with the optical tweezers in the implementation disclosed below). Running an annealing protocol (i.e. a single cycle thereof if there are more cycles) means that the annealing parameter is changed within its whole range. In the above example the value of λ is changed between 0 and 1 within a single run of the annealing protocol.

At the end of (a cycle) of calculation, the final state of the qubits is measured from which the final energy is determined (see operational step S135; final energy is the result of the annealing, it is not sure—however it is preferred—that it is the ground state energy, but the energy of the final state reached by the annealing operation). The annealing protocol can be preferably repeated multiple times (even without any change), since the final state will not be the same every time. This is due to the imperfections in the experimental implementation, but also to the quantum nature of the process. Both the values of the parameters and the final energies are stored (see operational step S140).

It is noted that the final energy is expected to be the ground state energy of the problem Hamiltonian according to the annealing principle (the system Hamiltonian is transformed into the problem Hamiltonian in course of the annealing, the other two terms, namely the initial Hamiltonian and the symmetry breaker term vanishes according to their A-dependent coefficient function). The final energy may be called by other names, like first energy, candidate for ground state energy, annealing result energy; it is the only relevant that this energy is the result of each of the one or more annealing protocol.

If the distribution of energies is broad, then the protocol—i.e. some parameters thereof—is preferably changed (in an operational step S145) in order to enhance adiabaticity.

Changing of the annealing protocol, i.e. to determine an altered annealing protocol may be done in several ways. E.g. the coefficient of the symmetry breaker term—i.e. the third annealing coefficient function—may be changed via changing simply the multiplication factor in the coefficient or via changing how the coefficient depends on λ, i.e. in the latter case the λ-dependence of the function can be changed (maintaining that this coefficient is zero at the beginning and at the end of the annealing). For example, in the above expression, γ=cλ(1−λ), the value of ‘c’ can be changed.

In certain cases, in a change of the annealing protocol, even the symmetry breaking term itself can be changed, i.e. the operators applied in it (e.g. it can be changed between the unitary and symplectic special embodiments). Generally, it can be chosen which embodiments or special/detailed embodiments are applied in such a change. Naturally, H₀ and Hₚ are typically not changed at changing the annealing protocol (but these can be changed if the boundary conditions prescribed for these coefficients are maintained). It is a slighter change applicable to the symmetry breaker term to change the values of the

$${n}_{i}^{x , y} or {η}_{i}^{x , y , z}$$

in it (see e.g. illustrated in Eqs. (6) and (7)).

The symmetry breaker term is naturally not set to zero for the annealing protocol (i.e. for the full annealing or for a cycle of it; see the test below as an exception). Accordingly, we can speak about the inventive method, if this term multiplied with its third annealing coefficient function is finite (nonzero) at least in a part of an annealing protocol (this is in accordance with that it is zero both at the beginning and at the end of (a cycle of) an annealing protocol; e.g. it can have zero points where the third annealing coefficient function is zero). Accordingly, we can say that the third annealing coefficient function is finite for some values of λ (or most of its values) for the applied values of λ. Naturally, also the operators of the symmetry breaking term are applied in a way that this term is set to be nonzero in itself (see the interpretation of this at Eqs. (6) and (7) giving illustration for the symmetry breaking term).

However, as a test, an annealing protocol can be performed in a way that the symmetry breaker term is not switched on at all (i.e. in a cycle, for example). This can be applied as a baseline test; however, this running/cycle is not covered by the invention.

Preferably, after multiple runs (with the help of a statistics built in operational step S150), the minimal energy value is preferably selected as the result of the calculation.

It is worth changing the protocol to see how stable the result is. If the width of the distribution of the final energy values is large (larger than e.g. the energy unit J—in the problems of this type J is often chosen as a unit of the energy, see also below at the figures; J is the coefficient of the first term of the problem Hamiltonian, if it may vary for indices i, j, then its average for i, j indices can be chosen as the energy unit), then it is sure that the calculation is still not good enough, but if this is not the case, then we cannot be sure that we are not finding an excited state. It is therefore preferable to run the protocol with more different parameter sets.

According to these aspects, the final result can be obtained in several ways, i.e. options can be chosen (e.g. multiple times repetition, changing of parameters). Thus, operational step S145 is optional in the invention, the method can be performed also without changing the parameters. Repeating the process (i.e. an annealing protocol) multiple times is also an option. Accordingly, the result of the method may be obtained even via a single running of the annealing protocol, but preferably the cycle determined by the loop corresponding to operational step S145 is repeated until sufficient data is obtained to build up the statistics of the final energy and to obtain the success probability (see also the stoppage criterion below). Building statistics helps to have sufficient quantity of results in order to obtain the ground state energy as a result of the annealing (it can be preferably selected based on the statistics from different final energies). It is accordingly noted that if there is only a single run of the annealing protocol, then the energy received in that run is the result of the calculation.

Accordingly, in an embodiment a plurality of annealing cycles is performed, wherein a respective annealing protocol is determined for each cycle and a respective final energy is obtained for each cycle as a result of performing the respective annealing protocol.

Thus, in order to achieve the optimal solution, the annealing protocol can be performed multiple times (this is a typical approach in the field of annealing). After each run, the final energy is measured and stored (a single number is obtained for energy in each run). The results of the different runs are compared to decide whether the lowest final energy value of the runs is accepted as a final result or more runs are needed. In the different runs various parameters of the protocol can be changed (see above; in this case a new problem instance is obtained, and the annealing is rerun).

In connection with a stoppage criterion for performing consecutive cycles (i.e. for not starting a next cycle after obtaining a certain final energy; it can be called termination or finishing criterion also) the followings are noted (moreover, a maximal number of cycles may be set).

In a case investigated above one can adjust the speed of the protocol by changing the T parameter (in this case λ(t)=t/T, but other choices are also possible to adjust the speed, see under Eq. (3) in the points). Different runs at a given speed will, in general, lead to different final energy results due to the quantum nature of the process. Performing multiple runs at a given speed makes it possible to monitor the distribution of the final energy which should be sufficiently narrow (comparable to energy unit J, see above; this may be introduced as a predetermined threshold for investigating whether the distribution is narrow enough), and to calculate the mean value of the final energy which is the estimate for the ground state energy.

Increasing T (i.e. lowering the speed) will lead to better estimate of the ground state energy, and one can monitor the change in the estimate between consecutive runs. When this change is sufficiently small, the result is considered to have converged (a predetermined convergence parameter can be chosen).

The protocol can also be altered by changing parameters (see above the possibilities). After such a change it is advisable to increase T in sufficiently small steps until convergence is reached. The converged energy values obtained for different protocols (these are stored in every cycle in operational step S140) are then compared and the lowest one is selected as the result of the quantum annealing calculation (see operational step S150, these converged energy values constituting the statistics built in this step, and the end of the process of FIG. 1 can be reached this way).

In the subsequent part, (special/detailed) embodiments will be provided. The method is tested for these systems for symmetry breaker terms lowering the symmetry by breaking down invariance against complex conjugation with keeping (symplectic symmetry breaker term) or without keeping (unitary symmetry breaker term) a symplectic symmetry.

The special/detailed embodiments (which may be generalized, see below) are illustrated herebelow on a one-dimensional random spin model having the following problem Hamiltonian,

$${H}_{P} = {\sum }_{i = 1}^{N - 1} {J}_{i} {Z}_{i} {Z}_{i + 1} + {h}_{1} {Z}_{1} \qquad ( 4 )$$

with Jᵢ independent Gaussian random variables of variance J, and the h₁Z₁ term eliminates the undesirable double degeneracy of the energy levels. J sets the units of energy and time, from hereon we set it to 1.

The initial Hamiltonian is in this example:

$${H}_{O} = - \frac{1}{N} {\sum }_{i = 1}^{N} {X}_{i} \qquad ( 5 )$$

In a first special/detailed embodiment, a unitary symmetry-breaker is utilized, for which a possible Hamiltonian:

$${H}_{U} = {\sum }_{i = 1}^{N} {n}_{i}^{x} {X}_{i} + {n}_{i}^{y} {y}_{i} . \qquad ( 6 )$$

Here

$${n}_{i}^{x} and {n}_{i}^{y}$$

are independent Gaussian random variables with zero mean and variances. Other choices could be to consider either only

$${n}_{i}^{y}$$

being independent Gaussian random variables with unit variance, or

$$( {n}_{i}^{x} , {n}_{i}^{y} )$$

being independent random vectors of unit length (i.e. the sum of the averages of their second power is set to be 1).

In a second special/detailed embodiment, a symplectic symmetry-breaker is utilized, for which a possible Hamiltonian:

$${H}_{S} = {\sum }_{i = 1}^{N} {y}_{i} ( {η}_{i}^{x} {X}_{a} + {η}_{i}^{y} {Y}_{a} + {η}_{i}^{z} {Z}_{a} ) . \qquad ( 7 )$$

Here \vec{S}=(Xₐ, Yₐ, Zₐ) acts on the auxiliary (ancilla) qubit, and

$${η}_{i}^{x} , {η}_{i}^{y} , {η}_{i}^{z}$$

are independent Gaussian variables with zero mean and ⅓ variances (in this case—because of the three components—these values correspond to unit length). Thus, the strength and the form of the coupling (selection of constant coefficients) between the auxiliary and base (problem) qubit(s) may be independent for each problem qubit (i.e. these are independent random numbers, that is, there is zero probability that two couplings will be exactly equal).

The followings are noted in connection with the symplectic symmetry-breaker of Eq. (7). For having a symplectic symmetry-breaker, it is enough if the Y-component of a base qubit is coupled to the ancilla qubit, it is not necessary to involve all Pauli operator components of the ancilla. Thus, Eq. (7) shows a Hamiltonian of a detailed embodiment, other symplectic Hamiltonians are conceivable, even starting from Eq. (7) itself. Starting from this: some of ηᵢ^{x}, ηᵢ^{y}, ηᵢ^{z} may be zero, it is enough if only one of them is non-zero for a given index i. Moreover, it is also not necessary that all of the base qubits are coupled to the ancilla qubit: for some values of index i, all of

$${η}_{i}^{x} , {η}_{i}^{y} , {η}_{i}^{z}$$

may be zero (see also below, where this detailed embodiment is mentioned).

As mentioned above the symmetry breaking term is set to be nonzero in itself through its operators. For the above cases, this means—since these are summed up terms for the base qubits—that there are finite terms. More specifically in the unitary case (Eq. (6)), the coefficient is finite at least for one base qubit, at least for the Yᵢ term thereof. In the symplectic case (Eq. (7)), the Yᵢ term of at least one base qubit is connected to the ancilla qubit (or, for Eq. (11) below at least one base qubit is connected to at least one ancilla).

Referring to the description of the flowchart of FIG. 1, a problem Hamiltonian is available as described there, which can also be thought of as a cost function. The ground state, that minimizes the cost function, can be a spin configuration with minimum energy depending on the coefficients Jᵢ and h₁. It is noted that H₀ also applied in the adiabatic framework can also be appropriately chosen according to the present example for Hₚ; the choice of the present H₀ for the above Hₚ is a standard choice in adiabatic calculations.

It is noted with emphasis that in the prior art approaches no such a term is chosen which would depend on the y-component of the spin, neither in H₀, nor in Hₚ in order to avoid possible problems that may originate from the complex-like nature of the y-component of the spin.

It is thus also noted that the symmetry breaker term applied in the invention goes against this prior art approach. It can be seen from the above that an appropriate complex conjugation symmetry breaker term can be chosen for a H₀−Hₚ pair (two examples are given above).

Above, an embodiment has been described by the help of the flowchart of FIG. 1. Moreover, options and exemplary realizations have been already given for some aspects of the invention in order to clarify what can be a part of the invention.

### 3. General Definition of the Invention

Herebelow, referring to the above illustrated details, the general definition of the invention is given.

The invention is a method for performing quantum annealing (quantum annealing computation) utilizing a quantum computer comprising a plurality of base quantum bits or (utilizing, or, by other word, using) a classical computer simulating the plurality of base quantum bits.

It is noted that the basic group of quantum bits are called here based quantum bits, since these have to be differentiated from the optional ancilla quantum bits (will be introduced below). At several places in the description, base quantum bits are written simply as quantum bits, but in case of ancillas, always the name ancilla quantum bit (q-bit) is used. Also, in the lack of the optional ancilla quantum bits, base quantum bits can be called simply quantum bits (qubits).

The method according to the invention comprises the following steps (references are given to the embodiment illustrated by the flowchart of FIG. 1):
a system Hamiltonian operator (somewhere shortly, Hamiltonian) describing the plurality of base quantum bits is determined, wherein the system Hamiltonian operator comprises an initial Hamiltonian operator term (H₀) and a problem Hamiltonian operator term (Hₚ; for determining H₀ and Hₚ, see operational steps S105, S110, respectively),
an annealing protocol of the quantum annealing for the system Hamiltonian operator (see operational step S120 for determining the annealing protocol) is determined, wherein in the annealing protocol the initial Hamiltonian operator term is multiplied (the terms of the system Hamiltonian have multiplicator factors, as shown by Eq. (3)) by a first annealing coefficient function having dependence on an annealing parameter (i.e. it is a function of the annealing parameter) and the problem Hamiltonian operator term is multiplied by a second annealing coefficient function having dependence on the annealing parameter, wherein the annealing parameter is changed from a beginning value to an end value during the annealing protocol, and wherein the first annealing coefficient function has unit value at the beginning value and zero value at the end value of the annealing parameter, and the second annealing coefficient function has zero value at the beginning value and unit value at the end value of the annealing parameter (these are a first part of the boundary conditions),
the quantum annealing is performed according to the annealing protocol (during the annealing protocol—i.e. during a single annealing protocol, if there are more cycles—the annealing parameter is changed from a beginning value to an end value, as introduced above; see for this step operational step S130 in which step running of the annealing protocol is performed), as a result of which a final energy is obtained at the end of the annealing protocol (see for this step operational step S135, in which step the final energy is measured, which means that the final energy is obtained in this step),
   wherein a symmetry breaker Hamiltonian operator term is involved (comprised) in the system Hamiltonian operator (see operational step S115 in this respect, where it is given that the symmetry breaker Hamiltonian operator term is also determined as a part of the system Hamiltonian operator; this involvement in the system Hamiltonian operator means that the above steps—i.e. the annealing—performed on the full system Hamiltonian operator, i.e. to the one which comprises the symmetry breaker Hamiltonian operator term), wherein the symmetry breaker Hamiltonian operator term is a complex conjugation symmetry breaker operator term (according to the above description, this term effectively breaks the complex conjugation symmetry), and in the annealing protocol the symmetry breaker Hamiltonian operator term is multiplied by a third annealing coefficient function having dependence on the annealing parameter, wherein the third annealing coefficient function has zero value at the beginning value and at the end value of the annealing parameter (these are a second part of the boundary conditions).

The complex conjugation symmetry breaker operator term is mentioned regularly in the description as symmetry breaker term (it is called also as a Hamiltonian and/or operator term, or even ‘term’ can be left from its name), i.e. abbreviated by not mentioning ‘conjugation symmetry’ at every occurrence (it can be called shortly also as breaker term) and can be simply denoted by Hₛ. This term—according to its role in the annealing process—could also be called as stabilizing term, since it helps (stabilizes) the annealing process in finding the ground state more quickly and with higher probability.

It is noted that the system Hamiltonian introduced above is a full Hamiltonian (or simply main, total or annealing Hamiltonian), describing a system subjected to the annealing (H₀, Hₚ, Hₛ with varying weight due to the annealing coefficient of them depending on the annealing parameter). Determining this system Hamiltonian meant in a wide sense, namely that decision is made on the various Hamiltonian terms (namely, the choice for H₀, Hₚ and Hₛ, one or more from these can be considered readily available) from which a system Hamiltonian is established.

The invention may also be related to an apparatus (system) for performing quantum annealing (may be also called annealing apparatus/system). The annealing apparatus comprises a quantum computer or a classical computer (with a simulation unit) as a main part having or simulating quantum bits (the apparatus preferably has a module or unit for these). The plurality of quantum bits can be described by the help of the system Hamiltonian operator. In other words, the system Hamiltonian operator, of course, describes the plurality (system) of quantum bits, not the whole annealing apparatus/system. This apparatus is adapted for performing the steps of the method according to the invention. Thus, the apparatus comprises a system Hamiltonian determining module (unit), an annealing protocol determining module, a quantum annealing performing module. All of them can be called a unit.

The above-mentioned plurality of base quantum bits may be called as a system of or ensemble of quantum bits. These are the quantum bits which are involved in an annealing computation (can be complemented by one or more ancilla quantum bits), i.e. these constitute a predefined (predetermined) set of quantum bits (e.g. the interactions are defined between them).

When the annealing protocol is determined, it is implemented on the annealing platform to facilitate the performing thereof (see operational step S125 between steps S120 and S130). Below, some details are given about an exemplary implementation of Hamiltonian operator terms on a quantum computer (it is emphasized here also that other implementations are also possible). Implementation on a classical computer is straightforward, since in this case the Hamiltonian operator terms for the quantum bits are needed to be simulated. Accordingly, one of these platforms (namely, a quantum computer or a classical computer) is utilized for performing the quantum annealing according to the annealing protocol. When the system is simulated on a classical computer, the operators are represented by matrices and we work with them. In contrast, in the experimental implementation (quantum computer), the operators are physically implemented.

In connection with the annealing coefficient functions introduced above, the following interpretation is given. Above, options and some exemplary values have been given for an annealing protocol, culminating in a general Eq. (3), where each term of the Hamiltonian have a respective coefficient. As an illustration, using the notations of Eq. (3), the following interpretations are given for the annealing coefficients of the above general definition of the invention (clearly showing that these depend on the λ annealing parameter, i.e. these are functions of this parameter):
α(λ) plays the role of the first annealing coefficient function,
β(λ) plays the role of the second annealing coefficient function, and
γ(λ) plays the role of the third annealing coefficient function.

Above, in connection with α, β and γ the boundary conditions are also given (in line with the above definition of the invention), as well as examples are given for the λ-dependency of these coefficients. In the above illustration of α, β and γ, A runs between 0 and 1, as typically selected. Other beginning and end values can be also chosen for λ (see also the next paragraph), the criterion is to have proper value for α, β and γ for beginning and end value (see above), since these are the coefficients of Hamiltonian terms (in other words, during the annealing, the Hamiltonian has to be transformed from H₀ to Hₚ).

The above linear choice (λ(t)=t/T) is a straightforward choice for the annealing parameter (called control parameter there), since it goes between 0 and 1 for the time interval [0, T]. However, λ could go between different end values, and other dependence on time than the linear dependence may be chosen (if the above-mentioned boundary conditions are met). λ is the parameter which shows where we are in the “deformation” which is applied according to the annealing protocol.

Moreover, as illustrated by the above exemplary choice for these coefficient functions, it is clear that there are many possible choices for the functions, i.e. for the dependency on λ, but boundary conditions have to be met. Simple polynomial dependences—i.e. polynomial functions for the coefficients—can be a good choice (fulfilling the prescribed boundary conditions, see above, where the proper boundary conditions are marked), as the above choice shows, since their zero points are easily adjustable.

According to the above definition, the third annealing coefficient function is a function having zero function value at the beginning value and at the end value of the annealing parameter. Naturally, it has non-zero (finite) function values in the interval between the beginning value and the end value of the annealing parameter to switch on the symmetry breaker Hamiltonian term (see also our comments above). A function being proportional with λ(1−λ) is a good choice because of its proper zero function values.

Moreover, preferably, in an embodiment the system Hamiltonian operator is described using (by means of) one or more type of Pauli operator, wherein the complex conjugation symmetry breaker operator term has, for at least one base quantum bit of the plurality of base quantum bits,
a single Pauli operator of type y, or
a product of odd number of Pauli operators of type y of the respective base quantum bit and of any of the plurality of the base quantum bits (since it is introduced as a product, it means that this odd number is larger than one).

The Pauli operator of type y (may also be denoted by type Y—however at many places in the description, this whole Pauli operator of type y is denoted by Y) may be called Pauli operator of second type or second Pauli operator considering the three Pauli operators, can be represented in matrix form as

$$[ \begin{matrix}0 & - i \\ i & 0\end{matrix} ] ,$$

where ‘i’ is the imaginary (complex) unit.

In this embodiment, therefore, the system Hamiltonian operator is described by the help of Pauli operators (as the equations illustrates, in many cases with all of the types, X, Y and Z; naturally, this depends on the represented system), i.e. the terms in the system Hamiltonian are represented by Pauli operators (preferably, all of the terms, i.e. H₀, Hₚ and symmetry breaker term; in case of having ancilla quantum bits, also that). It is meant under using (utilizing) Pauli operators for describing the system Hamiltonian operator that X, Y and Z are used in the Hamiltonian or Sₓ, S_{y} and S_{z} having only a multiplicator constant multiplying the Pauli operators, i.e. these are proportional (since S_{x/y/z}=h_{bar}/2*σ_{x/y/z}, where σₓ, σ_{y}, σ_{z} and X, Y, Z are different notations for the same operators).

Moreover, in the above-defined product, a special combination of a given base quantum bit and other base quantum bits (if any) may occur leading also to a complex conjugation symmetry breaker term (in the product the respective base quantum bit may have a role in the “any of the plurality of the base quantum bits”, since this can cover any quantum bit, but this term can cover also base quantum bits other than the respective base quantum bit).

This optional requirement gives a structure to the conjugation symmetry breaker term, i.e. it restricts how this term is defined. If there is a single Pauli operator of type y or a product of odd number of Pauli operator of type y in a term, then it is able to break the complex conjugation. A product of even number of Pauli operator of type y would not break this symmetry, since an even power of a Pauli operator of type y would not give a complex addition to the Hamiltonian. Thus, in this embodiment it is given about a term which is complex conjugation symmetry breaker in itself that how the complex symmetry breaking nature of it is provided.

Additional to the previous embodiment, preferably, the complex conjugation symmetry breaker operator term has a single Pauli operator of type y multiplied only with a constant coefficient (beside this, the complex conjugation symmetry breaker operator term may have other additional term not containing Pauli operator of type y). Accordingly, in this specialization, the Pauli operator of type y is multiplied only with a constant. This constant is typically dependent on the index of the quantum bit, this constant may be one in certain cases (e.g. for certain indices).

A special (detailed) embodiment within this specialization and the above embodiment is defined in Eq. (6) above (unitary symmetry breaker), where the Pauli operator of type y (denoted by Yᵢ) is multiplied with a constant

$${n}_{i}^{y}$$

coefficient (this is the term which ensures that Eq. (6) illustrates a further embodiment covered by the present embodiment). Moreover, Eq. (6) comprises an additional

$${n}_{i}^{x} {X}_{i}$$

term which does not alter the complex conjugation symmetry breaker nature of the Hamiltonian term (although, in the present embodiment—defined at the beginning of this paragraph—this additional term is not prescribed).

There is a further embodiment which is a further specialization of the above embodiment (comprising also ancilla quantum bits). Accordingly, in this further embodiment it is applied that the system Hamiltonian operator is described using Pauli operators (both the base quantum bits and the ancilla quantum bits), wherein the complex conjugation symmetry breaker operator term has, for at least one base quantum bit of the plurality of base quantum bits, a single Pauli operator of type y, or a product of odd number of Pauli operators of type y of the respective base quantum bit and of any of the plurality of the base quantum bits.

Furthermore, in this further embodiment in case the quantum computer is utilized for the method, the quantum computer comprises further one or more ancilla quantum bit, or, in case the classical computer is utilized for the method, the classical computer simulates further one or more ancilla quantum bit, and in the complex conjugation symmetry breaker operator term, for at least one base quantum bit of the plurality of base quantum bits,
the single Pauli operator of type y, or
the product of odd number larger than one of Pauli operators of type y of the respective base quantum bit and of any of the plurality of the base quantum bits
   is coupled to Pauli operator of one or more type of an ancilla quantum bit (from the one or more ancilla quantum bit; coupling to “Pauli operator of one or more type of an ancilla quantum bit“is preferably meant as it is shown in Eq. (7) and (11) that e.g. Yᵢ is coupled to the Pauli operators of different types of the ancilla one-by-one, i.e. to a linear combination thereof).

In the previous embodiments, in connection with the requirement “at least one base quantum bit of the plurality of base quantum bits” see also the respective equations—in particular Eqs. (6), (7) and (11)—, wherein summations are applied onto the base quantum bits, these requirements can be specialized also according to the expressions of the equations.

Accordingly, the single Pauli operator of type y of the base quantum bit or the above defined product is coupled to the ancilla, to one or more Pauli operator thereof. Thus, it can be coupled to a single Pauli operator of the ancilla (any of them: type x, y or z) or to two of them (to any two of them) or to all Pauli operators of the ancilla qubit (in the latter two case a summation can be formed, cf. Eqs. (7) and (11)).

A special (detailed) embodiment within this further embodiment is defined in Eq. (7) above and Eq. (11) below (symplectic symmetry breaker). In Eqs. (7) and (11) it can be seen that the Pauli operator of type y (Yᵢ) is multiplied with a constant coefficient

$$( {η}_{i}^{x , y , z} and {η}_{a}^{x , y , z} )$$

and also with the Pauli operators of the ancilla qubit (in Eqs. (7) and (11) to Pauli operators of all three types of an ancilla quantum bit).

H₀ and Hₚ are defined only on base quantum bits (these cannot contain any operator describing ancilla qubit), ancilla quantum bits are only introduced in the complex conjugation symmetry breaker operator term. Thus, ancillas are only “switched on” when the symmetry breaker operator term gives non-zero contribution (it gives no contribution at the beginning and at the end of the annealing, as defined in connection with the third annealing coefficient function).

It is noted in connection with the above introduced special (detailed) embodiments that these detailed embodiments are defined by the help of a respective equation which gives the full details, defines all terms of the Hamiltonian. However, these can be generalized in these more general embodiments.

It is also noted that since the whole system Hamiltonian is preferably described by the help of Pauli operators, the above general embodiments, as well as the special (detailed) embodiments are very good illustrations of how the invention can be implemented, i.e. these give good illustrations of a complex conjugation symmetry breaker operator term.

However, other representations (descriptions) are conceivable for a quantum bit in a Hamiltonian than the formalism using Pauli operators, i.e. a complex conjugation symmetry breaker operator term can be applied on a more general level according to the invention.

The present method can be implemented on quantum computers provided by cloud services such as those of QuEra (see in the next sections), on digital computers simulating numerically such systems, or in other, experimentally realized driven quantum systems. Other implementations of the present method may also be applicable, and the above detailed examples serve only as examples, however the fundamental method of exploiting the connection between the necessary annealing time and the underlying symmetry group of the system is a new unique method to improve the efficiency of the quantum adiabatic optimization.

### 4. Exemplary Implementation

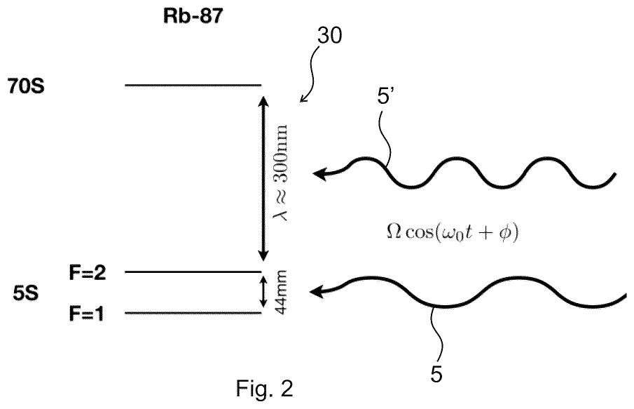

The Hamiltonian can be implemented, for example, on platforms using neutral cold atomic gases, such as the Aquila machine of QuEra (see J. Wurtz et al.: Aquila—QuEra's 256-qubit neutral-atom computer, arXiv: 2306.11727v1, Jun. 20, 2023); this is mentioned above as an exemplary implementation. In this exemplary implementation a qubit 30 is realized by two hyperfine states of the ⁸⁷Rb atom. The two states that realize the two (Z=1 and Z=−1) states of the qubit 30 are either the (5S,F=1, m_{F}=−1) and (5S,F=2, m_{F}=−2) hyperfine states or one of the 5S and 70S valence electron levels (see FIG. 2 for respective exciting laser beams 5 and 5′).

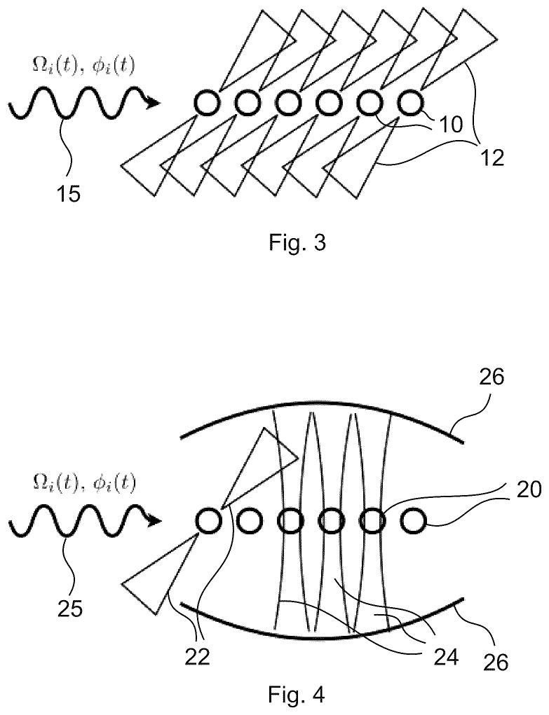

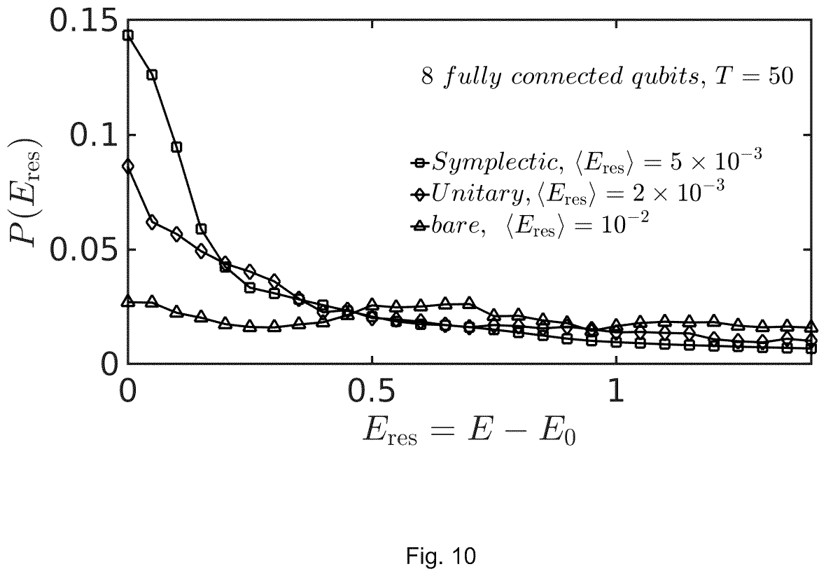

The atoms (see FIGS. 3 and 4, atoms 10 and 20 respectively, denoted by circles) are in a vacuum cell and held in position in the plane perpendicular to the figure by focused laser beams called optical tweezers (see tweezers 12 and 22 in FIGS. 3 and 10, denoted by respective triangles). The tweezers can be used to rearrange the atoms in an arbitrary two-dimensional pattern. Other laser beams are utilized to manipulate the atoms by inducing atomic transitions (see respective laser beams 15 and 25 in FIGS. 3 and 4, denoted by wavy arrow).

In the so-called rotating frame of the driving laser frequency, the atomic Hamiltonian of the j^{th} atom can be written as

$${{H}_{j} = \frac{{Ω}_{j} ( t )}{2} {e}^{i {ϕ}_{j} ( t )} \vert a 〉}_{j j} {〈 b \vert + \frac{{Ω}_{j} ( t )}{2} {e}^{- i {ϕ}_{j} ( t )} \vert b 〉}_{j j} {〈 a \vert + {Δ}_{j} ( t ) \vert b 〉}_{j j} 〈 b \vert , \qquad ( 8 )$$

where |a [symbol] ⱼ and |b [symbol] ⱼ denote the two states of atom j, Ωⱼ is the amplitude of the laser, also called the Rabi frequency, φⱼ is the relative phase of the laser, and Δⱼ is the detuning of the laser frequency with respect to the atomic transition frequency. The first term describes transition from state |b [symbol] ⱼ to |a [symbol] ⱼ, while the second term describes transition from state |a [symbol] ⱼ to |b [symbol] ⱼ. The last term expresses the energy difference of the two states, the energy of state |b [symbol] ⱼ is Δⱼ higher than that of state |a [symbol] ⱼ (the energy of level |a [symbol] ⱼ is set to zero for convenience).

In the two-dimensional Hilbert space spanned by the two atomic states the basis vectors are

$${{\vert a 〉}_{j} = ( \begin{matrix}0 \\ 1\end{matrix} ) and \vert b 〉}_{j} = ( \begin{matrix}1 \\ 0\end{matrix} ) .$$

Then—according to the bra-ket vector vectors are products—the first term can be represented by a matrix proportional to

$$( \begin{matrix}0 & 0 \\ 1 & 0\end{matrix} ) ,$$

the second term by

$$( \begin{matrix}0 & 1 \\ 0 & 0\end{matrix} ) ,$$

and the last term is proportional to

$$( \begin{matrix}1 & 0 \\ 0 & 0\end{matrix} ) .$$

This allows us to rewrite the Hamiltonian in terms of the Pauli matrices as

$${H}_{j} = \frac{{Ω}_{j} ( t )}{2} cos ( {ϕ}_{j} ( t ) ) {X}_{j} + \frac{{Ω}_{j} ( t )}{2} sin ( {ϕ}_{j} ( t ) ) {Y}_{j} + \frac{{Δ}_{j} ( t )}{2} ( {Z}_{j} + I ) . \qquad ( 9 )$$

Depending on the phase φⱼ, the first two terms realize time dependent couplings to the Pauli operators Xᵢ (for φⱼ=0) and Yⱼ (for φⱼ=π/2), while the detuning gives rise to an effective magnetic field in the z direction. The time dependence of these parameters can be adjusted by changing the strength, frequency, and phase of the lasers using acousto-optical modulators. This means that the different couplings can be modulated, as well as switched on and off according to a given protocol.

This realization corresponds to the system detailed as an example above (see FIGS. 3 and 4). Accordingly, the last term in the above Hamiltonian realizes the coupling to a magnetic field in the z-direction appearing in the problem Hamiltonian Hₚ (see second term of Eq. (4) above), the first term corresponds to the initial Hamiltonian H₀ (see Eq. (5) above) and the first two terms realize the unitary symmetry breaker term in Hu corresponding to magnetic fields in the x- and y-directions (see Eq. (6) above). Accordingly, the full Hamiltonian—handling the Xⱼ, Yⱼ, Zⱼ depending terms thereof summing them up—can be realized by the help of Hamiltonian Hⱼ of Eq. (8) (for a general Ising interaction, see also below).

The Ising interaction in the problem Hamiltonian, Σ_{i<j}JᵢⱼZᵢZⱼ, (see first term of Eq. (4) above) can be generated by various methods. In the Aquila machine, such terms are induced by the Rydberg mechanism. A Rydberg state is a highly excited state of the atom so the effective size of the atom becomes big. The energy of such an atom strongly depends on the state of the neighboring atoms. If two Rydberg atoms are close to each other, they have a large increase in their interaction energy. Exploiting this mechanism, the couplings Jᵢⱼ can be varied in time by moving the atoms closer or further from each other using the optical tweezers (see FIG. 3).

Alternatively, the atoms can be placed in a confocal cavity made of two mirrors (see FIG. 4, mirrors 26 are denoted by two arcs) whose distance is equal to their radius of curvature. In such a cavity, there are multiple resonant modes of the electromagnetic field with the same frequency. The atoms located in the midplane of the cavity scatter the driving laser field to a superposition of these modes (see FIG. 4, driving laser fields 24 are indicated by the three vertical shapes), which gives rise to a long-range Ising-type interaction between the atoms mediated by the electromagnetic field (B. P. Marsh et al.: Entanglement and Replica Symmetry Breaking in a Driven-Dissipative Quantum Spin Glass, Phys. Rev. X 14, 011026 (2024), see Eqs. (2) and (5) therein). Moreover, the strength and sign of this long-range Ising-type interaction depends on the positions of the atoms, so the problem Hamiltonian featuring all-to-all Ising couplings with multiple different coupling strengths can be realized. The strength of these couplings is also proportional to the power of the driving laser field by which the weight of the Ising term can be changed in time.

In the symplectic case, ancilla qubits are also realized by Rubidium atoms. They are distinguished from the other qubits by their different couplings involving the Y spin operator. This can also be achieved in the cavity setup. In the paper of Sarang Gopalakrishnan, Benjamin L. Lev, Paul M. Goldbart: “Exploring models of associative memory via cavity quantum electrodynamics”, Philosophical Magazine, 92:1-3, 353-361 (2012), it is shown that the photon-mediated interactions give rise to interaction terms of the form

$${\sum }_{i < j} M ( {r}_{i} , {r}_{j} ) ( {a}_{x} {X}_{i} {X}_{j} + {a}_{y} {Y}_{i} {Y}_{j} + {a}_{z} {Z}_{i} {Z}_{j} ) ,$$

where the coupling strengths M(rᵢ,rⱼ) depend on the position vectors rᵢ and rⱼ of the qubits. Using anisotropic couplings for which only a_{y} is non-zero, this realizes the symplectic breaker term (in a variant, also Eq. (7) can be modified to contain only such a term). By positioning the qubits in the cavity it can be achieved that M(rᵢ, rⱼ) is non-zero only for a subset of the base qubits and the ancilla qubits. The coupling strengths between the base qubits and the ancilla qubits can be tuned in time by changing the intensity of the lasers.

The first step of the adiabatic calculation is the preparation of the spins in the qubit system in the ground state of H₀. This is achieved by turning on the first (x-direction) term only, i.e., by adjusting the detuning, the phase, and the strength of the driving laser fields and/or by arranging the atoms in space. Then the coefficients of the various terms discussed above are changed according to the desired protocol. The coefficient of X-term is decreased while the strength of the Ising coupling is increased by adjusting the laser power and/or by moving the atoms closer to each other. In the unitary case, the Y-term is switched on and off during the process by changing the phase of the lasers continuously (or quasi-continuously) in time (cf. with coefficient functions above, it is noted here that, in accordance with this, the annealing parameter can be changed continuously/quasi-continuously using this implementation).

The final state of the qubits—i.e. the state reached at the end of a cycle of the protocol—is measured, in other words information about the final state is obtained in different ways in the two cases. In the Rydberg implementation (see FIG. 3), the optical traps are turned off during the quantum evolution (not to disturb the quantum evolution) and are turned back on at the end of the process (the calculation should be fast enough so that switching off the trap causes no problems). While atoms in the ground state are re-trapped by the lasers, the excited (Rydberg) states are anti-trapped which means that they are pushed out of the array of atoms. Detecting the presence or absence of atoms via fluorescence imaging thus measures the state.

In the cavity implementation (see FIG. 4), the phase of the light emitted by the atoms is locked to the spin state, so the state can be imaged by spatially measuring the emitted phase of the cavity light (e.g. by the help of a spatial heterodyne measurement). This is done by splitting the original laser field into two beams. One beam is used to radiate the atoms, and then the light emitted from the cavity is interfered with the other beam to provide phase interference information.

Accordingly, detecting the final state (i.e. the measurement) is typically destructive. This implies that a new initial state must be prepared for the next adiabatic simulation cycle, which will obviously be different to some extent because the preparation will understandably be subject to uncertainties. However, even if the adiabatic protocol does not change, it is still worth running the protocol again with a new—theoretically the same—preparation, as it can give some feedback on how good the parameter set is. Of course, the protocol can also be changed for the next cycle.

### 5. Results

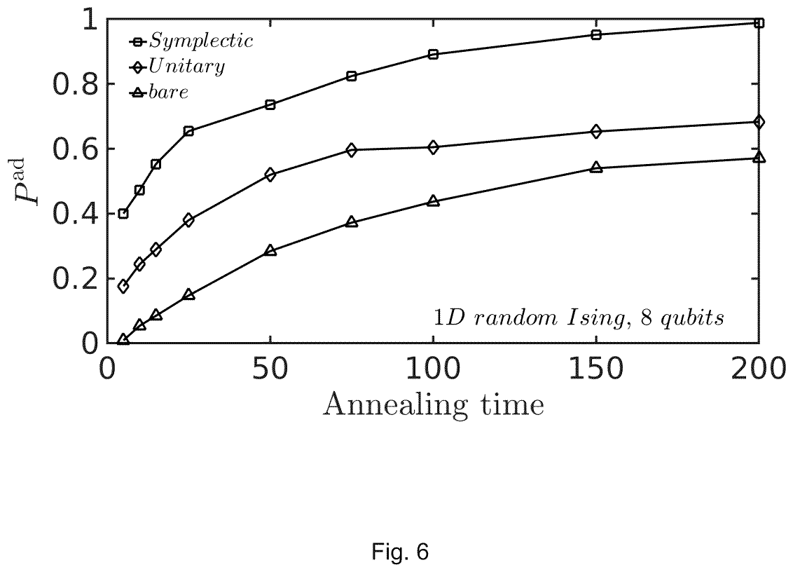

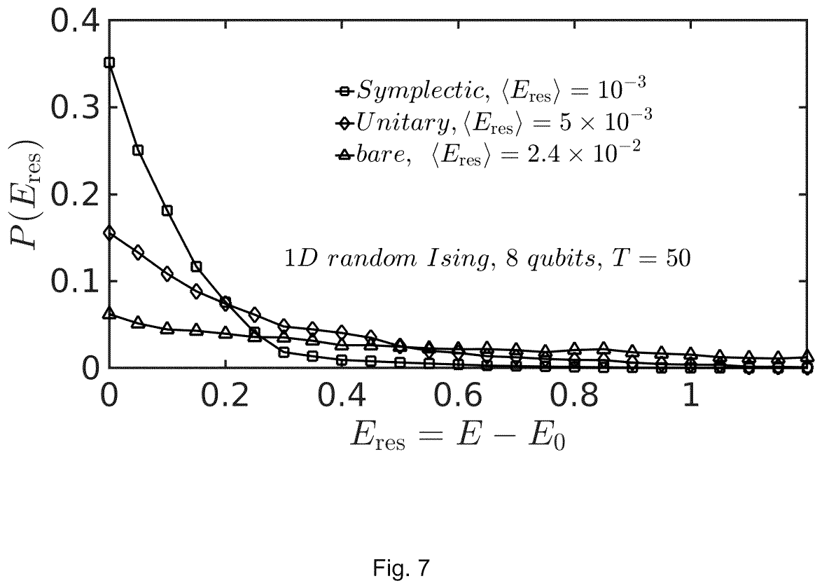

The results regarding the speed up of quantum annealing are shown in FIG. 5, FIG. 6, and FIG. 7. The notations are the same for all of FIGS. 5-10, simple dashed line denotes the symplectic case, the dashed line with dashes having alternating length denotes the unitary case, and the line with triangles denotes the bare case (for the interpretation of the cases, see above).

FIG. 5 shows the evolution of the gap between the ground state and the first excited state during the deformation from the initial Hamiltonian to the problem Hamiltonian for a typical instance for the disordered one-dimensional (1D) Ising model with 8 qubits (see Eqs. (4) and (5) for the above-mentioned Hamiltonians). This system of qubits corresponds also to FIGS. 6 and 7. In the 1D Ising model, there is a coupling between the neighboring spins (qubits), and there is a coupling to, according to the above problem Hamiltonian, only one spin at the ends (one-dimensional chain). The coupling parameters (J) are random numbers with Gauss distribution with variance J (J is set to be 1, i.e. unit value; h₁ is a Gauss variable with variance of 1). There is a single ancilla for the symplectic case with a random coupling to all (normal, eight) qubits (see Eqs. (6) and (7) for the unitary and symplectic symmetry breaker terms applied for the figures). In the annealing protocol Eq. (3) and λ-dependence of coefficient functions given just below it are utilized.

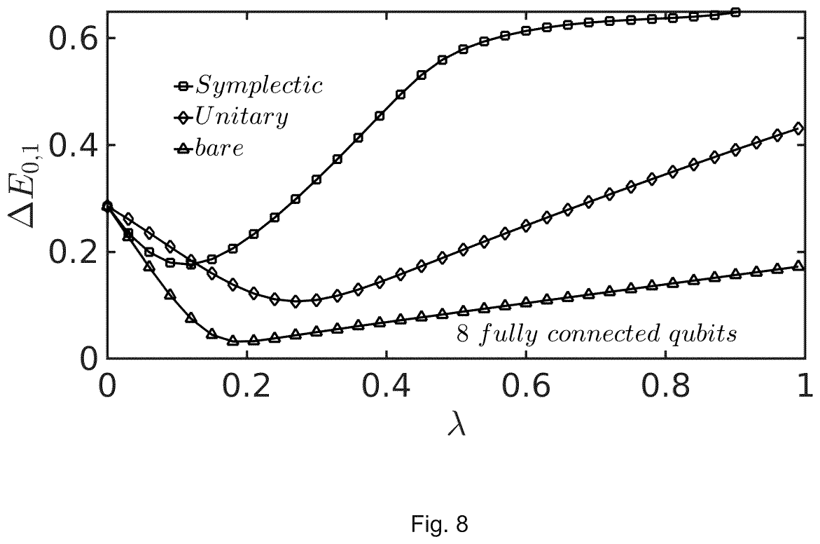

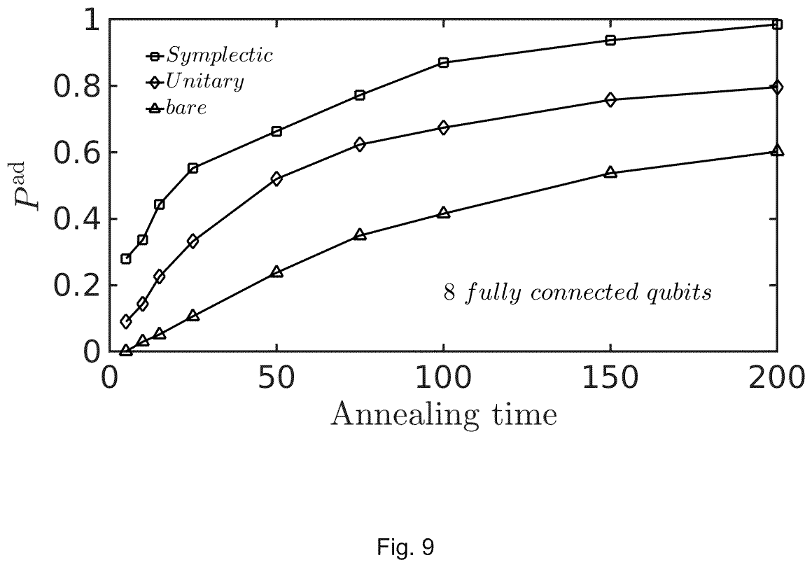

It is noted that FIGS. 5-10 were obtained using 100 samples of the random couplings in the Hamiltonian. FIGS. 5 and 8 show the size of the gap averaged over these realizations. Similarly, FIGS. 6 and 9 were obtained by calculating the probability of adiabaticity for each realization and then averaging them. FIGS. 7 and 10 show the probability distribution of the final energy obtained by building a histogram of the measured energies in the realizations. Accordingly, FIGS. 5-10 represent a typical instance thanks to the applied averaging.

Thus, in FIG. 5 it is shown for a typical instance, how the gap at which the adiabatic evolution breaks down gets increased due to the breaker. The largest gap is observed for the symplectic perturbation (the symmetry breaker term can be considered to represent a perturbation-switched on during the annealing-on the approach based on initial and problem Hamiltonians), but the unitary approach also increases the gap compared to the unstabilized process (the bare process, i.e. where no symmetry breaker term is applied), and thereby reduces the computational time of an adiabatic calculation.

FIG. 6 shows the average probability of reaching the final ground state as a function of the annealing time (this is the annealing time (T) applied in a cycle, T is in 1/J units where h_{bar}=h/(2π) is chosen to be one, see above). The stronger the symmetry breaking the less time it takes for the simulation to reach with a given probability the final ground state. In alternative wording, the average probability of finding the final ground state increases much faster with the annealing time in the presence of symmetry breaker terms (accordingly, shorter annealing times can be chosen). FIG. 6 shows that the unitary case is more efficient than the bare approach (with no symmetry-breaking Hamiltonian term). Moreover, the symplectic breaker is more efficient than the unitary one: much higher probabilities (close to 1) can be reached with that. We refer to the description of the invention in the introductory part, where it has been detailed why it is so advantageous to obtain the results much faster.

Accordingly, time is measured in 1/J units, as well as the energy (for the different graphs of FIGS. 5-10) is measured in J units (see e.g. y-axis of FIG. 5 or x-axis of FIG. 7, and their analogies in FIG. 8 and FIG. 10); thus e.g. E=2 means E=2J.

Results of an adiabatic optimization are shown in FIG. 7 for the same model as in FIGS. 5 and 6. FIG. 7 shows the distribution of the final energy measured from the ground state of the problem Hamiltonian for annealing time of T=50 (in 1/J units as given above). FIG. 7 shows the probability distribution of the energy measured at the end of the process, based on many runs. If there is a large peak around Eᵣₑₛ=0, it means that there is a high probability of finding the ground state. If, on the other hand, this distribution is wide, the probability of running the calculation into a relatively high energy state is not small either, so not appropriate result can also be obtained. The graph also gives the expectation value (<Eᵣₑₛ>) of the final energy measured from the ground state for each case.

FIG. 7 shows that for the bare process, excitations far from the ground state are also possible (the graph for the bare case is flat, with comparatively high probabilities also for higher energies), while the lower the symmetry is, the more peaked the distribution becomes around zero, implying a lower probability for the final state to differ from the final ground state. Accordingly, the symmetry breaking terms shift the energy distribution to lower energies, and yield much better estimates for the ground state energy.

As a further example for problem Hamiltonian, in the fully connected random spin model, also referred to as the Sherrington-Kirkpatrick model (see in this context the 3-SAT problem mentioned in the introduction which is a related model to the Sherrington-Kirkpatrick model; the 3-SAT problem can be transformed onto a problem based on spins, and, thus, it is expected that it can be satisfactorily handled by the help of the invention, see also A. Lucas, Ising formulations of many NP problems, Frontiers Phys. 2, 5 (2014).), also used to model the stock market, every qubit is coupled to all other qubits with independent Gaussian couplings of variance 1/N,

$${H}_{P} = {\sum }_{i > j = 1}^{N - 1} {J}_{i , j} {Z}_{i} {Z}_{j} + {h}_{1} {Z}_{1} \qquad ( 10 )$$

wherein J_{i,j}˜Gauss(0, 1/N) and h₁˜Gauss(0,1), there is the mean value and the variance in the brackets.

In FIGS. 8-10 the results for fully connected qubits are illustrated. Accordingly, in this model there is a coupling not only between neighboring qubits as for FIGS. 5-7, but the is a coupling between all qubits, i.e. between arbitrary pairs of qubits, as the above Hamiltonian shows in Eq. (10). Possible breaker Hamiltonians are the same as in case of FIGS. 5-7. Similar efficiency improvements are observed in FIG. 8, FIG. 9, and FIG. 10 as in the previous case illustrated in FIGS. 5-7, and, FIGS. 8-10 exhibit the same phenomena as in the previous case.

According also to the figures (especially, FIGS. 6 and 9), T may be chosen to be 10-200 1/J, more preferably 10-100 1/J; and—as illustrated good results can be achieved at lower T also.

It is also a strong indicator of the speed-up efficiency of the method that the annealing times to reach a success probability of P=0.5 exhibit a strongly increasing tendency: for the one-dimensional Ising model of FIGS. 6, T=132, 46 and 12 are needed for the bare, unitary and symplectic cases, respectively. For the fully connected qubits in FIG. 9, the corresponding times are T=132, 47, 20.

In the following a further symplectic symmetry breaker term is disclosed (i.e. a further exemplary symmetry breaker term is illustrated).

The symplectic method may be realized in many different ways. Some currently used quantum computers have a local geometry, where all-to-all qubit couplings are difficult to realize. In the example above, we have used a single ancilla. One can use, however, several ancillas, a=1, . . . , A, to realize symplectic symmetry breaker terms. The symplectic symmetry breaker of the form

$${H}_{S} = {\sum }_{a = 1}^{A} {\sum }_{i ϵ {G}_{a}} {Y}_{i} ( {η}_{a}^{x} {X}_{a} + {η}_{a}^{y} {Y}_{a} + {η}_{a}^{z} {Z}_{a} ) \qquad ( 11 )$$

couples groups of (base) qubits, denoted by Ga, to a given ancilla (comparison of Eqs. (7) and (11) illustrates that one or more ancilla quantum bit may be utilized).

In case of Eq. (11), therefore, there are a plurality of ancilla quantum bits (the outer summation is for the ancilla qubits from 1 to A). At the same time, the base qubits are summed up in groups for each ancilla. In this case, members of the equation can be interpreted so that only those base qubits are classified to groups which are connected to an ancilla (vice versa: those base qubits which has no connection with an ancilla, do not appear in the expression).

### 6. Comments on Prior Art

Herebelow, comments are given on some pieces of the prior art mentioned in the introduction.

In the Albash article as well as in the Tang and Kapit article introduced in the introduction no such intermediate Hamiltonian term is applied where the time-reversal symmetry would be broken by introducing a term depending in such a way on Pauli operator of type y which is non-transformable away, i.e. cannot be transformed away. In other words, in the invention the Pauli operator of type y cannot be eliminated (i.e. it is non-eliminable) via transformation from the Hamilton-operator, i.e. it is non-eliminable.

On the contrary, it is emphasized that it seems to be relevant to the prior art approaches to avoid such symmetry breaking (the term dependent y-directed spin can be transformed away, i.e. it is not complex conjugation symmetry breaking, see the comments on Tang and Kapit article in the introduction), it seems that the prior art approaches wished to maintain the full Hamiltonian within the same symmetry ensemble. This intention is substantiated in Kapit and Oganesyan article, where it is stated that “[t]his allows us to make a number of analytical predictions, and perform specialized numerical calculations, that would be difficult or impossible to formulate in other contexts”. Also, since a σₓ*σₓ or Sₓ*Sₓ type expression is used in the Albash article in the intermediate term, the time-reversal symmetry breaking is avoided in this prior art too (this applies for any quadratic combination of Pauli operators).

Thus, it is also emphasized that the approach applied according to the invention (i.e. to use an intermediate Hamiltonian term effectively breaking complex conjugation symmetry) was unexplored and goes against the trends applied in the field of adiabatic calculations.

Furthermore, it is noted in connection with US 2023/0106489 A1 that it is not clear that those described in in what respect could be considered to be a stabilizer. It is further noted that it cannot be considered to be an intermediate Hamiltonian in the meaning of the invention. It has not got that role, since it is not a term switched on temporarily in an adiabatic process. It seems that the Hamiltonian in describes the system, for which a plurality of possible applications are listed, e.g. adiabatic quantum computations (see [0104]). Despite this prior art document mentions such an application option, it is not given how the approach disclosed in the document could be used in that field. There is also no instruction given to use it as an intermediate Hamiltonian temporarily switched on. Thus, it can be assumed that the Hamiltonian of could be typically used as the problem Hamiltonian of adiabatic calculations.

It is noted in connection US 2023/0214700 A2 that symmetry-breaking has a different meaning in it according to the introduction: as mentioned above, in the document everything is called symmetry-breaking which does not commute with the problem Hamiltonian operator. However, for quantum adiabatic calculations it is indispensable to have non-commuting terms, this is exactly what it makes them quantum-based (non-classical). Thus, in the terminology of US 2023/0214700 A2 quantum adiabatic methods could always be called symmetry breaking. Moreover, it is clear that complex conjugation symmetry breaking does not appear in US 2023/0214700 A2.

Moreover, in this prior art a technical approach from a different field of variational quantum algorithms is applied. To sum up, a symmetry-breaking intermediate Hamiltonian used in adiabatic calculation does not occur either in US 2023/0214700 A2. Additionally, the ground state-which can be considered as a target—is not known in our approach. However, in US 2023/0214700 A2 they want to prepare the target state so that they know it in advance for a specific purpose, for example to use it for something.

The inventive solution is expected to perform well in the following examples (these examples constitute a non-exclusive list just like the above shown examples for the Hamiltonian terms), where the problem Hamiltonian corresponds to any combination of the following problems: Bayesian optimization, black-box optimization, gradient-free optimization, gradient-based optimization, a first-order or second-order optimization, a gradient descent optimization, a stochastic gradient descent optimization, an adaptive gradient descent optimization, a Nelder-Mead optimization, a Powell optimization, constrained optimization by linear approximation (COBYLA), and a Broyden-Fletcher-Goldfarb-Shannon (BFGS) optimization.

The invention is, of course, not limited to the preferred embodiments described in detail above, but further variants, modifications and developments are possible within the scope of protection determined by the claims.

1. A method for performing quantum annealing utilizing a quantum computer comprising a plurality of base quantum bits (30) or a classical computer simulating the plurality of base quantum bits (30), the method comprising the steps of
determining (S105, S110) a system Hamiltonian operator describing the plurality of base quantum bits (30), wherein the system Hamiltonian operator comprises an initial Hamiltonian operator term and a problem Hamiltonian operator term,
determining (S120) an annealing protocol of the quantum annealing for the system Hamiltonian operator, wherein in the annealing protocol the initial Hamiltonian operator term is multiplied by a first annealing coefficient function having dependence on an annealing parameter and the problem Hamiltonian operator term is multiplied by a second annealing coefficient function having dependence on the annealing parameter, wherein the annealing parameter is changed from a beginning value to an end value during the annealing protocol, and wherein the first annealing coefficient function has unit value at the beginning value and zero value at the end value of the annealing parameter, and the second annealing coefficient function has zero value at the beginning value and unit value at the end value of the annealing parameter,
performing (S130) the quantum annealing according to the annealing protocol, as a result of which a final energy is obtained (S135) at the end of the annealing protocol,
characterized in that a symmetry breaker Hamiltonian operator term is involved (S115) in the system Hamiltonian operator, wherein the symmetry breaker Hamiltonian operator term is a complex conjugation symmetry breaker operator term, and in the annealing protocol the symmetry breaker Hamiltonian operator term is multiplied by a third annealing coefficient function having dependence on the annealing parameter, wherein the third annealing coefficient function has zero value at the beginning value and at the end value of the annealing parameter.

2. The method according to claim 1, characterized in that the system Hamiltonian operator is described using one or more type of Pauli operator, wherein the complex conjugation symmetry breaker operator term has, for at least one base quantum bit (30) of the plurality of base quantum bits (30),
a single Pauli operator of type y, or
a product of odd number of Pauli operators of type y of the respective base quantum bit (30) and of any of the plurality of the base quantum bits (30).

3. The method according to claim 2, characterized in that in case the quantum computer is utilized for the method, the quantum computer comprises further one or more ancilla quantum bit, or, in case the classical computer is utilized for the method, the classical computer simulates further one or more ancilla quantum bit, and in the complex conjugation symmetry breaker operator term, for at least one base quantum bit (30) of the plurality of base quantum bits (30),
the single Pauli operator of type y, or
the product of odd number of Pauli operators of type y of the respective base quantum bit (30) and of any of the plurality of the base quantum bits (30)
is coupled to Pauli operator of one or more type of an ancilla quantum bit.

4. The method according to claim 1, characterized in that a plurality of annealing cycles (175) is performed, wherein a respective annealing protocol is determined for each cycle and a respective final energy is obtained for each cycle as a result of performing the respective annealing protocol.
